(19) United States
(12) Patent Application Publication
(10) Pub. No.: US 2003/0092783 A1
(43) Pub. Date: May 15, 2003

(54) Process for recovering materials from rubber molded articles and materials recovered

(76) Inventors: Yoshitaka Udagawa, Kanagawa (JP); Shinji Kawakami, Kanagawa (JP); Toshio Fukuda, Kanagawa (JP); Susumu Ashizawa, Kanagawa (JP)

Correspondence Address: David T. Nikaido, RADER, FISHMAN & GRAUER, PLLC, Suite 501, 1233 20th Street, NW, Washington, DC, 20036, US

(21) Appl. No.: 10/205,436

(22) Filed: Jul. 26, 2002

(30) Foreign Application Priority Data
Jul. 26, 2001 (JP) 2001-225680

(51) Int. Cl. C08F 2/00

(52) U.S. Cl. 521/38

(57) ABSTRACT

This invention provides a process for recovering materials from a rubber molded article containing carbon black and rubber comprising the steps of

(1) subjecting the rubber molded article to at least one pretreatment selected from the following:

(a) a heat treatment at a temperature in the range of 220 to 400° C. wherein shape of the articles before the heating is substantially preserved, and

(b) a treatment of applying a shearing force,

(2) extracting the product of (1) with an organic solvent for separation into the solvent extract and the extraction residue,

(3) removing the solvent from the separated solvent extract to thereby recover the rubber.

(4) subjecting the separated extraction residue to either one of the following:

(i) heating to a temperature of 500° C. or higher, and

(ii) dissolving in a rubber solvent containing 0.01 to 50% of a peroxide to thereby decompose the rubber component and recover the carbon black.

### BACKGROUND OF THE INVENTION

This invention relates to a process for recovering materials from a rubber molded article and materials recovered, and more specifically, to a process for recovering a high purity, high molecular weight rubber component and/or a high quality carbon black from vulcanized or unvulcanized molded articles such as tire, rubber tube, and other discarded rubber products, and scrap rubber, and the materials recovered.

Disposal of industrial waste, and in particular, recovery and recycling of raw materials from industrial wastes has nowadays become a serious social problem. In the case of discarded rubber products such as tires, the amount discarded is enormous, and recovery and recycling of the raw materials included in the rubber products is highly desirable. A rubber, however, is quite stable once it has vulcanized, and recovery of rubber, carbon black, and other materials of the quality that can be recycled as raw materials from the discarded rubber is quite difficult.

For example, when materials are to be recovered from the discarded rubber, the most typical process is decomposition of the rubber at a high temperature (generally at least 500° C.) or high pressure (generally at least 2 MPa). Catalysts and solvents adapted for use in such decomposition at an elevated temperature or pressure are proposed in various patent publications, for example, in U.S. Pat. No. 3,704,108 B, U.S. Pat. No. 3,996,022, EP 71789 B, JP 60-40193 A, and JP 7-310076 A.

In the decomposition at an elevated temperature or pressure as described above, the rubber component is recovered in the form of gaseous, low molecular weight hydrocarbon or oil, and recovery of the a high molecular weight rubber which can be recycled in the rubber production with no further processing has been difficult. With regard to the carbon black, recovery of the carbon black which is equivalent in quality with the virgin carbon black has been generally difficult once the rubber is decomposed at a high temperature. In addition, in the case of high pressure decomposition, carbon black is obtained as a mixture with hardly separable oil (or undecomposed cross-linked rubber), and recycling of carbon black in such case has been extremely difficult if not impossible.

Accordingly, apart from the scrap tires which are recycled with their tire form preserved, most of the discarded rubber is incinerated as a fuel without being recycled, and only about 10% of the discarded rubber is used as reclaimed rubber or powder rubber (Tire Recycling Handbook, Volume of Recycling Technology, Edited by Japan Automobile Tire Association and Japan Tire Recycling Association).

A known method of reclaiming the rubber is pan process, and various proposals have been made to improve physical properties of the rubber reclaimed by the pan process. For example, JP 10-310662 A and JP 9-227724 A propose use of a twin screw extruder in order to apply complex rubbers such as natural rubber and SBR or discarded vulcanized rubbers such as EPDM a large shear force at an elevated temperature which can not be applied by the use of a finishing roll so that the rubber can be dispersed into minute particles without leaving large rubber domain, and to thereby improve the rubber dispersibility. The devulcanized rubber recovered by such method still contains the carbon black, and in the case such rubber, the strand extruded from the twin screw extruder is generally revulcanized for press forming with no further processing.

### SUMMARY OF THE INVENTION

In view of the situation as described above, an object of the present invention is to effectively recycle discarded rubbers such as tires and scrap rubbers by chemical recycling. To be more specific, an object of the present invention is to provide a process for recovering materials from molded rubber articles, namely, a process which is capable of recovering high purity, high molecular weight rubber components and/or high quality carbon black which can be used as rubber raw materials with no further processing from vulcanized/unvulcanized molded rubber in an easy and convenient manner; materials recovered by such process; and rubber compositions wherein such recovered materials are recycled.

Rubber molded articles such as tires do not exhibit any substantial change in their outer appearance, and decomposition can not be confirmed by their outer appearance when they are heated to a low temperature (for example, approximately 300° C.) which is lower than the temperature that had been used in the thermal decomposition of such rubber molded articles. It is also well known that, vulcanized bulk rubber does not undergo substantial change except for slight swelling when immersed in an organic solvent. As described above, methods have been proposed for the reclaiming the rubbers by applying heat and shear to the vulcanized rubber. However, no process has been known to separately recover high purity rubber material or carbon black from the reclaimed rubber. The inventors of the present invention have made investigations in order to recover (chemically recycle) both the rubber and the carbon black in recyclable state from rubber molded articles such as discarded rubbers and scrap rubbers, and unexpectedly found that recovery of high purity, high molecular weight rubber as well as high quality carbon black is possible when the rubber articles are heat treated at a low temperature, and thereafter extracted by using an organic solvent. This finding has been filed as a patent application. The inventors made further investigations, and found that, when shearing treatment is combined with such process as a pretreatment of the solvent extraction, cleavage of molecules is efficiently promoted by synergy of heat and shear, and increase in the yield is realized. The present invention has been completed on such finding.

On the bases of the finding as described above, the inventors of the present invention made further investigations on the preliminary heating and extraction, and found that the process as described above is a commercially useful process enabling reliable, easy recovery of a high molecular weight, liquid rubber. It was also found that use of such method enables recovery of high purity, liquid polyisoprene having an average molecular weight (Mw) of approximately 15,000 which had been difficult to obtain by conventional thermal decomposition method from the vulcanized articles molded from the rubber of standard tire formulation, and that a rubber of even higher molecular weight can be recovered by adequately selecting the conditions within the temperature range of the preliminary heat treatment.

With regard to the extraction residue, it was also found that carbon black which can be reused as a high quality material can be easily recovered by thermally decomposing the rubber component at a high temperature, or by dissolving the rubber component by using a particular rubber solvent. The present invention is also based on such finding.

In the process for recovering materials from a rubber molded article of the present invention, there are provided as a first aspect of the invention, a process for recovering a rubber component as the material in the rubber molded article to be recovered; as a second aspect, a process for recovering carbon black; and as a third aspect, a process for recovering both the rubber component and the carbon black.

To be more specific, the present invention provides the process of recovering materials from rubber molded articles according to the aspects as described below.

<First Aspect of the Invention>

According to first aspect of the present invention, there is provided a process for recovering rubber components from a rubber molded article. This process comprises the steps of:

(1) subjecting the rubber molded article to at least one pretreatment selected from the following:

(a) a heat treatment at a temperature in the range of 220 to 400° C. wherein shape of the articles before the heating is substantially preserved, and

(b) a treatment of applying a shearing force,

(2) extracting the product of (1) with an organic solvent for separation into the solvent extract and the extraction residue, and

(3) removing the solvent from the separated solvent extract to thereby recover the rubber.

The pretreatments (a) and (b) may be carried out by selecting only one from these pretreatments; by conducting both (a) and (b) in consecutive manner; or by simultaneously conducting (a) and (b). Preferably, the pretreatments (a) and (b) are accomplished simultaneously.

The rubber recovered is preferably a liquid rubber having an average molecular weight (Mw) of 50,000 or more.

The extraction residue may be either discarded, or subjected to the step (4) as described below for further recovery of the carbon black.

<Second Aspect of the Invention>

According to second aspect of the present invention, there is provided a process for recovering carbon black from a rubber molded article. This process comprises the steps of:

(1) subjecting the rubber molded article containing carbon black and rubber to at least one pretreatment selected from the following:

(a) a heat treatment at a temperature in the range of 220 to 400° C. wherein shape of the articles before the heating is substantially preserved, and

(b) a treatment of applying a shearing force,

(2) extracting the product of (1) with an organic solvent for separation into the solvent extract and the extraction residue, and

(4) subjecting the separated extraction residue to either one of the following:

(i) heating to a temperature of 500° C. or higher, and

(ii) dissolving in a rubber solvent containing 0.01 to 50 wt % of a peroxide to thereby decompose the rubber component and recover the carbon black.

The pretreatments (a) and (b) may be carried out by selecting only one from these pretreatments; by conducting both (a) and (b) in consecutive manner; or by simultaneously conducting (a) and (b). Preferably, the pretreatments (a) and (b) are accomplished simultaneously.

When the extraction residue is subjected to (i), the rubber components in the extraction residue are removed by decomposition through combustion. In the case of (ii), the rubber components are removed by dissolution into the rubber solvent.

<Third Aspect of the Invention>

According to third aspect of the present invention, there is provided a process for recovering rubber components and carbon black from a rubber molded article. This process comprises the steps of:

(1) subjecting the rubber molded article containing carbon black and rubber to at least one pretreatment selected from the following:

(a) a heat treatment at a temperature in the range of 220 to 400° C. wherein shape of the articles before the heating is substantially preserved, and

(b) a treatment of applying a shearing force,

(2) extracting the product of (1) with an organic solvent for separation into the solvent extract and the extraction residue,

(3) removing the solvent from the separated solvent extract to thereby recover the rubber.

(4) subjecting the separated extraction residue to either one of the following:

(i) heating to a temperature of 500° C. or higher, and

(ii) dissolving in a rubber solvent containing 0.01 to 50 wt % of a peroxide to thereby decompose the rubber component and recover the carbon black.

The pretreatments (a) and (b) may be carried out by selecting only one from these pretreatments; by conducting both (a) and (b) in consecutive manner; or by simultaneously conducting (a) and (b). Preferably, the pretreatments (a) and (b) are accomplished simultaneously.

In the present invention according to the first, second, and third aspects as described above, each steps may be carried out as described below, which may be used in any desired combination.

In step (2), the solvent extraction may be immersion in toluene at a temperature of 0 to 40° C. of the rubber molded article which had been heat treated in the step (1).

In step (4) (i), in the heating of the extraction residue to a temperature of 500° C. or higher, the rubber component is decomposed into gaseous hydrocarbons to thereby recover the carbon black as the decomposition residue.

In step (4) (ii), the rubber solvent used is toluene containing 0.01 to 50% of benzoyl peroxide.

<Fourth Aspect of the Invention>

According to fourth aspect of the present invention, there are provided products of the present invention which are produced by any one of the processes as described above.

The product may be a rubber recovered by any one of the above-described recovering processes, wherein the rubber recovered is a liquid rubber having an average molecular weight (Mw) of 50,000 or more.

The rubber may be isoprene rubber.

Alternatively, the rubber may be butyl rubber.

Furthermore, product may also be carbon black recovered by any one of the above-described recovering processes.

Still further, the product may be a rubber composition containing at least one of the rubber and the carbon black as described above recovered from a rubber molded article.

Several processes have been proposed for extraction of the rubber components from a bulk rubber for the purpose of identifying the rubber component. For example, D. W. Carlson et al., Analytical Chemistry 42, 1278 (1970) proposes extraction using carbon disulfide after heating the bulk rubber to a temperature of 200° C. Other proposals include processes including the step of refluxing with o-dichlorobenzene, nitrobenzene, or other organic solvent. Since the aim of these processes are identification of the rubber component, the rubber is heated to a temperature of 200° C., or approximately 210° C. in the case of refluxing with nitrobenzene. In other words, it may be construed that these processes indicate some possibility of recovering the rubber component from a vulcanized rubber. Indeed, these processes are quite satisfactory in identifying the rubber component. The amount of the rubber extracted, however, is quite small, and such processes were never deemed as a process which could be generally applied to the rubber composition.

As described above, extraction of rubber components using an organic solvent has never been deemed as an industrially applicable rubber recovery process, and no investigation was conducted. Also, no substantial investigation has been conducted on the recovery of high quality carbon black from discarded rubber.

### BRIEF DESCRIPTION OF THE DRAWINGS

FIG. 1 is a view schematically showing the process flow of the present invention.

FIG. 2 is a view showing IR spectrum of the isoprene rubber produced in Example 1.

FIG. 3 is a view showing IR spectrum of the isoprene rubber produced in Example 2.

FIG. 4 is a view showing stress-strain curve of the vulcanized rubber produced by using the recycled rubber.

FIG. 5 is a view showing tan δ property in relation to the temperature of the vulcanized rubber produced by using the recycled rubber.

FIG. 6 is a view showing stress-strain curve of the vulcanized rubber using the recycled carbon black.

FIG. 7 is a view showing tan δ property in relation to the temperature of the vulcanized rubber produced by using the recycled carbon black.

FIG. 8 is a view showing IR spectrum of the butyl rubber produced in Example 5.

FIG. 9 is a view showing IR spectrum of the isoprene rubber produced in Example 6.

FIG. 10 is a view showing IR spectrum of the butyl rubber produced in Example 7.

### PREFERRED EMBODIMENT OF THE INVENTION

The present invention provides a process for recovering materials from rubber molded articles, the materials of the rubber molded articles recovered by such recovering process, and the rubber composition containing such recycled materials.

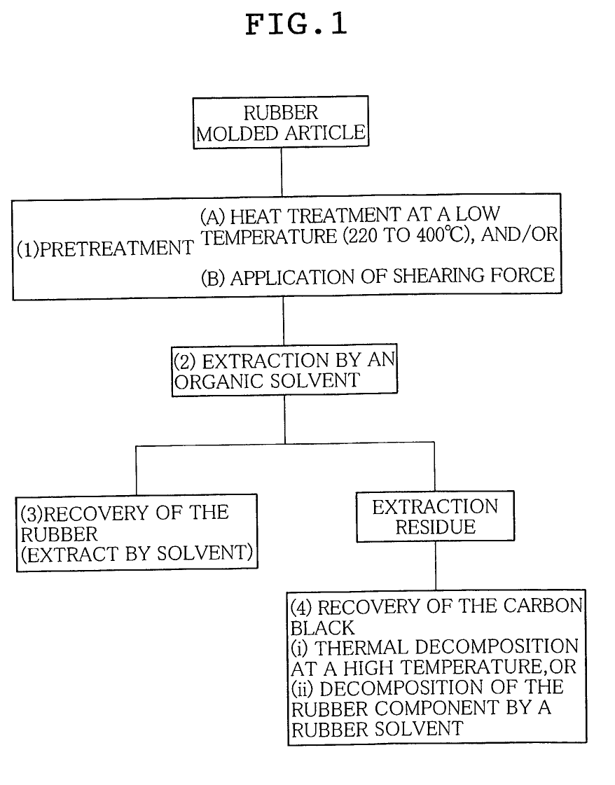

Next, the present invention is described in further detail by referring to FIG. 1 which is a view schematically showing the process flow of the present invention.

In the process for recovering materials from a rubber molded article of the present invention, the material typically recovered are rubber and/or carbon black. In the following description, the process of recovering the rubber is referred to as the first aspect of the invention, the process of recovering the carbon black is referred to as the second aspect of the invention, and the process of recovering both the rubber and the carbon black is referred to as the third aspect of the invention. These processes do share the similar steps. However, when materials are recovered from rubber molded articles in a large, industrial scale, numerous decision are to be made for each step and for various steps depending on the intended use of the recovered material, for example, as to which type of the rubber is to be recovered, which type of the rubber with what molecular weight is to be recovered, whether the rubber components should be discarded or not in recovering the carbon black, and the like. The product produced by such process is referred to as the fourth aspect of the invention. In all of these aspects of the invention, the process comprises the step (1) of subjecting the rubber molded product to a pretreatment, and the subsequent step (2) of extracting the product of the step (1) with an organic solvent.

(1) Pretreatment Step

The rubber molded articles treated by the recovery process of the present invention is not particularly limited with regard to their shape or the components other than the rubber component as long as the articles comprise molded rubber. The rubber molded articles are also not limited to vulcanized rubbers, and the articles may also comprise, an unvulcanized rubber, a partly vulcanized rubber, a mixture of a vulcanized rubber and an unvulcanized rubber, or a composite material with other constituent materials.

The rubber molded articles may be those formed by using virgin rubbers such as natural rubber (NR), isoprene rubber (IR), styrene-butadiene rubber (SBR), butadiene rubber (BR), butyl rubber (IIR), and chloroprene rubber (CR), and blend of such rubbers.

The rubber composition may also contain a filler which may be carbon black, silica, zinc oxide, calcium carbonate, or other filler of known type. The type of the filler is not particularly limited.

The rubber molded article used for the rubber recovery according to the first aspect of the invention may or may not contain carbon black. However, the rubber molded article used in the second, third, and forth aspects of the invention contains carbon black as will be described below.

The rubber molded article may be an article which has been vulcanized with a vulcanization system (vulcanizer, vulcanization promoter, vulcanization aid, etc.) such as sulfur; non-elemental sulfur vulcanizers such as tetramethylthiuram disulfide and tetraethylthiuram disulfide; bismorpholine disulfide, dipentamethylenethiuram tetrasulfide, organic peroxide, quinone dioxime, phenol-formaldehyde resin, a mixture of nitroso compound and diisocyanate, zinc oxide, magnesium oxide, zinc peroxide, triethylenetetramine, methylene dianiline, diphenylguanidine, hexamethylenediamine carbamate, ethylenediamine carbamate, bis-p-aminocyclohexylmethane carbamate, stearic acid, and oleic acid.

The rubber molded article may be the one comprising two or more rubber components, two or more vulcanizing systems, and two or more fillers; or the one further containing known resins, elastomers, compounding ingredients, or rubber subsidiary materials. For example, the rubber molded article may have added thereto an activating agent, vulcanization retarder, softener, plasticizing agent, adhesive, tackifier, vulcanizer, foaming agent, foaming aid, reinforcing agent, antiaging agent, colorant, pigment, flame retardant, or mold release agent.

The materials which may constitute the rubber composite material include a steel member as in the case of a steel cord or a fiber as in the case of a polyester carcass cord.

The components included in the rubber molded article are also not limited for their content. For example, when the rubber molded article is a tire, carbon black is typically included at an amount of about 50 parts by weight, and other additives are typically included at a total amount of about 10 parts by weight per 100 parts by weight of the rubber.

The rubber molded article as described above may be, for example, natural rubber tire, synthetic rubber tire, bladder, liner, tube, or other automobile/automobile-related rubber components; cable, belt, hose, sheet, packing, or other rubber products; or scraps produced in kneading or processing or other scrap produced in the molding. The rubber molded article may not necessarily be the one that has been used. The rubber molded article, however, is preferably a discarded material.

Exemplary scrap rubbers that have not been used include molding scraps of different forms discarded in the production of tires and other rubber products such as rubber scraps discarded in the step of kneading or molding due to early vulcanization or uneven vulcanization (yellowing or scorching), defective rubbers discarded in the vulcanization step due to the so called “sagging”, uneven vulcanization leaving vulcanized and unvulcanized parts, insufficient overall cross-linking, or the like, and those having a structural member such as steel member or organic fiber attached thereto.

Among such materials, use of tires and molding scraps from the tire production is preferable since they are discarded rubbers which enable recovery of natural rubber and isoprene rubber of high purity. For example, discarded rubber molded articles containing at least 60% by weight, and preferably, at least 80% by weight of tire tread (bent edge formed in the molding) can be used as a material to mainly recover natural rubber or isoprene rubber. Discarded rubber molded articles containing at least 60% by weight, and preferably, at least 80% by weight of bladder (a member in the interior of the mold used in the vulcanization) can be used as a material to mainly recover butyl rubber since butyl rubber is a high cost material, and recovery of such butyl rubber from the discarded automobile rubber parts or bladder that had been produced from the butyl rubber is highly recommended.

In the present invention, the rubber molded articles are subjected to step (a) wherein the rubber molded articles are heat treated at a temperature of 220 to 400° C. The heat treatment conditions in this step including the temperature and the time are such that the shape of the articles before the heating is substantially preserved. It is to be noted that in the process as will be described below wherein the rubber molded articles are simultaneously subjected to the step (a) wherein the rubber molded articles are heat treated at a temperature of 220 to 400° C., and the step (b) wherein shearing force is applied to the rubber molded articles, heating conditions including the temperature and the time are selected so that the shape of the articles before the heating would be substantially preserved if no shear force were applied under equivalent conditions.

It is to be noted that, in the present invention, the shape of the articles before the heating is described to have been substantially preserved when no substantial change in the outer appearance has occurred. For example, in the case of a rubber molded article having a cube shape, the cube shape is preserved throughout the heat treatment. In contrast, if the solid undergoes thermal decomposition or dissolution in a solvent, the shape of the solid will be collapsed at least in some parts by the change of the solid into the liquid or gas. Such collapsing of the shape is referred to as the decomposition of the molded article.

The equipment which may be used in the heating may be an oven, a tube furnace, or the like.

The rubber may be heated either in air or in an inert atmosphere such as nitrogen gas. However, when the denaturing (oxidation) of the rubber is to be avoided, the rubber is preferably heated in an inert atmosphere. When heating of the rubber is continued at the temperature within the range as described above, no readily recognizable change is likely to take place while slight change in the outer appearance may be induced in the case of heating in the air. No substantial trouble is likely to be induced by such a slight denaturing although such denaturing can be confirmed by means of IR spectrum. It should also be noted that the preheating in the air, compared to the heating in an inert atmosphere, is likely to result in the recovery of the rubber having a lower average molecular weight (Mw) and a molecular weight distribution with two or more peaks in the subsequent step (3). In such a case, the high molecular weight component may be further separated as desired.

The conditions used in the heating may vary according to the materials (rubber molded articles) being treated and the atmosphere in the treating. The heat treatment conditions, however, may be adequately selected from the temperature range of 220 to 400° C. depending on the desired molecular weight and the yield of the recovered rubber. The molecular weight and the yield of the recovered rubber are more likely to be affected by the temperature than the time of heating. To be more specific, when the heating is accomplished at a temperature on the low temperature side of the above-specified range, recovery of a high molecular weight rubber will be enabled at the compensation of the yield, while the heating at a temperature on the high temperature side of the above-specified range will enable rubber recovery at a high yield while the rubber recovered will have a lower molecular weight.

The temperature of the preheating as described above, is the temperature at the normal pressure. While the preheating is typically accomplished at the normal pressure, the preheating may also be accomplished under the pressure conditions other than the normal pressure, and in such a case, the temperature selected may be the temperature at the selected pressure which corresponds to the temperature at the normal pressure.

The time of heating is typically about 10 minutes, and preferably about 15 minutes although the time may vary depending on the heating conditions. No significant increase in the rubber yield is realized by increasing the heating time, and the rubber molecular weight is likely to become reduced with the increase in the heating time. Therefore, the heating time is about 40 minutes at the maximum, and preferably about 30 minutes at the maximum.

To be more specific, when the rubber molded article pretreated is the article produced by using butyl rubber, the rubber is heated to the temperature in the range of 300 to 380° C., more preferably 300 to 350° C., and most preferably 330 to 350° C.

When the rubber molded article pretreated is the article produced by using isoprene rubber, the rubber is preferably heated to the temperature in the range of 220 to 300° C., since heating to a temperature in such range enables extraction and recovery of the high molecular weight having an average molecular weight (Mw) of 15,000 or higher in the subsequent steps. The preheating temperature of the isoprene rubber molded article is preferably in the range of 220 to 280° C., and more preferably 220 to 250° C. When the preheating is accomplished within such favorable temperature range, recovery of the rubber having an average molecular weight (Mw) of 30,000 or higher, and desirably, 50,000 or higher will be enabled by the heating in air, and recovery of the rubber having an even higher molecular weight will be enabled by the heating in an inert gas atmosphere.

The preheating of the isoprene rubber molded article is described more specifically. For example, when vulcanized rubber (standard tire) in the form of cubes (2 mm×2 mm×2 mm) is filled in a tube furnace (heat resistant tube) at a concentration of 7 to 15 kg/m³, and heated in nitrogen atmosphere for 15 minutes, if the rubber is heated at 250° C. for 15 minutes, the isoprene having a Mw of about 84,000 is recovered at an yield of 30% or higher, and if the rubber is heated at 280° C., the isoprene having a Mw of about having a molecular weight of about 76,000 is recovered at an yield of 70% or higher.

It is to be noted that the yield is determined by using the rubber molded article (vulcanized article) of known composition as the starting material, subjecting the rubber molded article to the steps of the present invention, and dividing the weight of the recovered rubber by the weight of the rubber in the starting material used for the recovery.

In the present invention, the rubber molded articles are also subjected to the pretreatment step (b) wherein shearing force is applied to the rubber molded articles. The shearing treatment may be conducted at room temperature only with the heat generated by the shearing. When the shearing force is applied typically with an abrasion tester, a high purity rubber with reduced thermal denaturing can be recovered as the final product.

It is to be noted that a “high purity rubber” is a rubber wherein no or little oxidation (C═O) peak is found by IR spectrum which reflects the microstructure.

The shearing treatment may also be conducted with heating, and high molecular weight rubber is recovered at a high yield. In this case, when the rubber is heated to a temperature in the range of 220 to 400° C., thermal denaturing is suppressed and recovery of high purity rubber is enabled. The temperature may be adequately selected within such range depending on the desired molecular weight and yield of the recovered rubber although the adequate temperature may vary with the material heated (rubber molded article), atmosphere, and the like. The temperature of the preheating as described above, is the temperature at the normal pressure. The preheating may also be accomplished under the pressure conditions other than the normal pressure, and in such a case, the temperature selected may be the temperature at the selected pressure which corresponds to the temperature at the normal pressure.

The equipment used in such pretreatment is not particularly limited, and heating and shearing can be accomplished at once by using a single or twin screw extruder, grinder, abrasion tester, buffing machine or the like.

The rubber molded article after such shearing treatment is typically in the form of powder, mass, strands, and the like.

The rubber may be heated either in air or in an inert atmosphere such as nitrogen gas. However, when the denaturing (oxidation) of the rubber is to be avoided, the rubber is preferably heated in an inert atmosphere. When heating of the rubber is continued at the temperature within the range as described above, no readily recognizable change is likely to take place while slight change in the outer appearance may be induced in the case of heating in the air. No substantial trouble is likely to be induced by such a slight denaturing although such denaturing can be confirmed by means of IR spectrum. It should also be noted that the preheating in the air, compared to the heating in an inert atmosphere, is likely to result in the recovery of the rubber having a lower average molecular weight (Mw) and a molecular weight distribution with two or more peaks in the subsequent step (3). In such a case, the high molecular weight component may be further separated as desired.

With regard to the conditions used in the heating, the molecular weight and the yield of the recovered rubber are more likely to be affected by the temperature than the time of heating. To be more specific, when the heating is accomplished at a temperature on the low temperature side of the above-specified range, recovery of a high molecular weight rubber will be enabled at the compensation of the yield, while the heating at a temperature on the high temperature side of the above-specified range will enable rubber recovery at a high yield while the rubber recovered will have a lower molecular weight.

The time of heating is typically about 10 minutes, and preferably about 15 minutes although the time may vary depending on the heating conditions. No significant increase in the rubber yield is realized by increasing the heating time, and the rubber molecular weight is likely to become reduced with the increase in the heating time. Therefore, the heating time is about 40 minutes at the maximum, and preferably about 30 minutes at the maximum.

When the rubber molded article pretreated is the article produced by using butyl rubber, the rubber is preferably heated to the temperature in the range of 220 to 350° C., and more preferably 250 to 330° C. When the rubber molded article pretreated is the article produced by using isoprene rubber, the rubber is heated to the temperature in the range of 220 to 300° C., since heating to a temperature in such range enables extraction and recovery of the high molecular weight having an average molecular weight (Mw) of 15,000 or higher in the subsequent steps.

The preheating temperature of the isoprene rubber molded article is preferably in the range of 250 to 280° C. When the preheating is accomplished within such favorable temperature range, recovery of the rubber having a Mw of 30,000 or higher, and desirably, 50,000 or higher will be enabled by the heating in air, and recovery of the rubber having an even higher molecular weight will be enabled by the heating in an inert gas atmosphere.

In the pretreatment as described above wherein the shearing and the heating are conducted at once, the heat required in the preliminary treatment for the extraction can be reduced compared to the pretreatment wherein the rubber is heat treated with no shearing force applied. Such pretreatment is particularly preferable for the pretreatment of butyl rubber molded articles wherein pretreatment at a higher temperature is required compared to the isoprene rubber molded articles, and recovery of the high purity butyl rubber is enabled.

To be more specific, when a bladder (butyl rubber molded article) is introduced in a twin screw extruder (screw diameter, 44 mm; L/D=50) and pretreated by shearing at a rotation speed of 250 rpm and a cylinder interior temperature of 300° C. for 7 minutes, a high purity butyl rubber having a Mw or 100,000 or more is produced at an yield of not less than 80%.

(2) Organic Solvent Extraction Step

The thus pretreated rubber molded article is then extracted with a solvent for separation of solvent extractable (soluble) content. To be more specific, the rubber molded article that has been heat treated in the step (1) is typically immersed in an organic solvent in order to extract the solvent soluble content. In this step, it is possible to heat the organic solvent. However, in view of the operational cost, this step is carried out by the immersion in an organic solvent at room temperature (generally at a temperature in the range of about 0 to 40° C.). The immersion is preferably continued for at least 10 hours, and the rubber is typically immersed overnight.

The organic solvent is preferably used in an amount that allows full immersion of the solid rubber molded articles therein, and 1 kg of the rubber molded articles is immersed in the organic solvent at an amount of at least 1 liter, preferably 1 to 20 liters, and typically about 8 to 10 liters.

Preferably, the pretreated articles such as those in the form of strands are divided into small pieces by such means as cutting to thereby improve the extraction efficiency.

The organic solvent used may be a saturated or unsaturated hydrocarbon which may be aromatic, aliphatic, or alicyclic. Exemplary such organic solvents include benzene, toluene, xylene, hexane, decalin (decahydronaphthalene), tetralin (tetrahydronaphthalene), cyclohexane, and mixtures thereof.

Among these, the preferred are hexane, toluene, and xylene.

Next, the solvent extract and the extraction residue (insoluble content) are separated by means of centrifugation, filtration, or other versatile means.

(3) Rubber Recovery Step

In the process for recovering materials from rubber molded articles according to the first aspect of the invention, rubber is recovered from the solvent extract separated as described above by removing the organic solvent. The organic solvent can be removed by such means as distillation.

The process as described above enables recovery of a high molecular weight rubber. For example, in the case of the recovery from isoprene rubber molded articles, preheating at 220 to 300° C. enables recovery of a high molecular weight, liquid rubber having an average molecular weight (Mw) of 15,000 or more, preferably 50,000 or more, and more preferably 70,000 or more although the Mw of the recovered rubber may vary depending on the heating conditions of the preheating step (1)-(a). When necessary, a high molecular weight rubber having a molecular weight as high as 90,000 or more can be recovered by extraction. In the case of the recovery from butyl rubber molded articles, preheating at a preferable temperature range of 300 to 350° C. enables recovery of a liquid rubber having a Mw of 30,000 or more and preferably 50,000 or more at a high yield. When featured on molecular weight, recovery a high molecular weight, liquid rubber having a molecular weight as high as 100,000 or more is possible.

When the process of the present invention is applied for the rubber recovery from molded articles containing 60% or more of tire tread (bent edge formed in the molding), recovery of isoprene rubber in the form of a high molecular weight, liquid rubber is enabled. To be more specific, recovery of a high molecular weight, liquid rubber having an average molecular weight (Mw) of 15,000 or more is enabled at an yield of 80% or more, and favorably, recovery of the one having an average molecular weight (Mw) of 50,000 or more is enabled at an yield of 70% or more, and more favorably, recovery of the one having an average molecular weight (Mw) of 70,000 or more is enabled at an yield of 30% or more.

When the process of the present invention is applied for the rubber recovery from molded articles containing 60% or more of bladder, recovery of butyl rubber in the form of a high molecular weight, liquid rubber is enabled. To be more specific, recovery of a high molecular weight, liquid rubber having an average molecular weight (Mw) of 25,000 or more is enabled at an yield of 80% or more, and favorably, recovery of the one having an average molecular weight (Mw) of 60,000 or more is enabled at an yield of 50% or more.

The rubber recovered in the present invention may contain sulfur and other vulcanizing agents that had been included in the starting rubber molded articles. If necessary, the recovered rubber can be further treated with methanol, water, or the like for further purification.

The recovered rubber is generally recyclable in new rubber products, and this rubber is highly useful when used in the new rubber products thanks to the high molecular weight.

Unless otherwise noted, the rubber molecular weight referred in the present invention is the average molecular weight (Mw) which is measured by gel permeation chromatography (GPC) according to the standard method in the art.

Although the Mw of the recovered rubber may vary depending on the heating conditions of the pretreatment step (1)-(b), in the exemplary case of the recovery from isoprene rubber molded articles, pretreatment at 220 to 300° C. enables recovery of a high molecular weight, liquid rubber having an average molecular weight (Mw) of 15,000 or more, preferably 50,000 or more, and more preferably 70,000 or more. When necessary, a high molecular weight rubber having a molecular weight as high as 90,000 or more can be recovered by extraction. In the case of the recovery from butyl rubber molded articles, pretreatment at a preferable temperature range of 300 to 330° C. enables recovery of a rubber having a Mw of 50,000 or more at a high yield. When featured on molecular weight, recovery a high molecular weight rubber having a molecular weight as high as 100,000 or more is possible.

(4) Carbon Black Recovery Step

In this step, carbon black may be recovered from the solvent extraction residue that have been separated from the solvent extraction residue in the step (2)

(i) by thermally decomposing the rubber component by heating to a temperature of 500° C. or higher, or

(ii) by decomposing the rubber component by dissolution in a rubber solvent containing 0.01 to 50% of a peroxide.

The step (i) wherein the rubber component is thermally decomposed by heating to a temperature of 500° C. or higher is preferably carried out such that the amount of the organic component (primarily comprising the rubber component) on the surface of the carbon black is reduced to the level equivalent to or less than the level of the amount of the organic component on the fresh (virgin) carbon black.

The rubber component is thermally decomposed in this step into gaseous hydrocarbon and/or oil. Decomposition of the rubber component into gaseous hydrocarbon is preferable since the carbon black can be recovered as decomposition residue with no further processing.

To be more specific, the solvent extraction residue is heated in a nonoxidizing atmosphere typically to a temperature of 500° C. to 1500° C., and preferably 500° C. to 1000° C. for 30 seconds or longer, preferably 5 to 120 minutes, and more preferably 7 to 60 minutes.

Use of such temperature in the heating enables removal of the rubber component from the carbon black with no turning of the carbon black to be recovered into graphite.

The toluene extraction residue is preferably divided into small pieces to enable uniform heating, and loaded in the furnace not too compact for increase in the efficienty of the thermal treatment. For example, in a preferable embodiment, the vulcanized rubber (standard tire) in the form of cubes (2 mm×2 mm×2 mm) is filled in a tube furnace (heat resistant tube) at a concentration of 7 to 15 kg/m³, and heated in nitrogen atmosphere.

It is to be noted that the amount of the rubber components and other organic components on the surface of the carbon black may be determined by weight loss in thermogravimetric analysis (TGA) in a non-oxidizing atmosphere at 20° C. to 700° C.

In the case of virgin carbon black, typical amount of the organic components on the surface of the carbon black expressed in terms of the weight loss of the sample at 20° C. to 700° C. is in the range of 1.5% to 2.5% provided that the weight of the sample at 20° C. is 100%. It is preferable that the carbon black recovered by thermal decomposition (i) exhibits weight loss at 20° C. to 700° C. of up to 2.5%, and preferably, in the range of 1% to 2% which is equivalent with that of the virgin carbon black.

As described above, the carbon black recovered is well adapted for recycling, and the rubber composition produced by using this recovered carbon black has an equivalent tensile modulus and an equivalent loss tangent, or a larger tensile modulus and a smaller loss tangent compared with that of the rubber composition prepared by blending the ordinary carbon black. The reason for this is not yet clear. However, the inventors of the present invention believe that such favorable quality of the recovered carbon black is realized by the absence or extremely reduced amount of the organic component on the surface of the carbon black.

As described above, when the thermal decomposition step (i) is conducted subsequent to the steps (1) and (2), the resulting carbon black is provided with the high quality which has been difficult to achieve by the conventional thermal decomposition, and this recovered carbon black can by recycled in various applications just as in the case of the virgin carbon black.

In the present invention, the carbon black recovery step (4) may also be accomplished by the step (ii) wherein the solvent extraction residue is dissolved by a rubber solvent.

The rubber solvent used in the present invention is an organic solvent containing a peroxide at a concentration of 0.01 to 50%, preferably at 0.1 to 10%, and more preferably at 0.5 to 2%.

The peroxide used may be any of known organic peroxides, and exemplary such peroxides include benzoyl peroxide, diisopropylbenzene hydroperoxide, t-butyl hydroperoxide, p-methane hydroperoxide, cumene hydroperoxide, and other organic peroxides as well as radical generators such as azobisisobutyronitrile. Such peroxide may contain water or the like for the purpose of preventing explosion.

The organic solvent used may be any conventional organic solvent which is liquid at normal pressure and normal temperature and capable of dissolving the peroxide. Typical such organic solvents include hydrocarbons and alcohols. The hydrocarbon used may be either a saturated or an unsaturated hydrocarbon which may be aromatic, aliphatic, or alicyclic. Exemplary such organic solvents include benzene, toluene, xylene, hexane, decalin (decahydronaphthalene), methanol, ethanol, tetralin (tetrahydronaphthalene), and cyclohexane. The alcohols as described above may contain water as in the case of commercially available alcohols, and it is also possible to use the one which has been further diluted with water.

Among these, the preferred are those which are capable of swelling the rubber at room temperature, and use of an aromatic hydrocarbon such as toluene, benzene, and xylene is preferable.

To be more specific, the solvent extraction residue containing at least the vulcanized rubber and the filler is immersed with optional agitation in an organic solvent containing 0.01 to 50% of peroxide such that the ratio of the carbon black-containing composition (mg) to the organic solvent (ml) is up to 50, and preferably up to 30 to thereby separate the filler component.

It is to be noted that the rubber solvent may contain two or more organic solvents and/or two or more peroxides, and also, other optional components as long as the merits of the present invention is not impaired. Among the rubber solvents as mentioned above, the most preferred is benzoyl peroxide/toluene solution.

When the solvent extraction residue is immersed in the rubber solvent, the solvent extraction residue becomes dissolved/decomposed, and a suspension containing the liquidified rubber component and the carbon black is obtained.

The rubber solvent is used in an amount that allows full immersion of the solvent extraction residue therein, and the treatment is preferably conducted with stirring. The treatment may be carried out at a room temperature (normally, up to 40° C.), and there is no need to use an elevated temperature. For example, when 1% benzoyl peroxide/toluene solution is used, the solvent extraction residue is treated at room temperature typically for about 40 to 50 hours, and preferably for about 60 to 70 hours.

As a result of such treatment, the solvent extraction residue becomes dissolved/decomposed by the rubber solvent, and a mixture of the decomposition products in the form of nonviscous suspension is obtained. When the suspension is allowed to stand for a while, insoluble content mainly comprising the carbon black is obtained as a precipitate.

The separation of the precipitate and the clear solution containing the rubber decomposition products may be facilitated by any of conventional means such as centrifugation, membrane separation, decantation and filtration.

The thus recovered precipitate usually contains a small amount of rubber component (which is detectable by analysis such as gas chromatography and TGA) together with the main component, the carbon black. Typical weight ratio of the carbon black to the rubber component is about 100:20. This precipitate can be recycled as the carbon black with no further separation.

The thus recovered carbon black has the ability of forming a rubber composition having excellent damping properties as in the case of the ordinary carbon black. Accordingly, the recovered carbon black is well adapted for use in such application as seismic isolation rubbers or and tires.

In the meanwhile, the solution mainly contains the liquid rubber whose molecular chain has been cleaved. The solution may also contain a minute amount of peroxide that had been included in the rubber solvent, decomposition products of such peroxide, and sulfur or other vulcanizing agent.

When this solution is treated as in the case of step (3) by removing the organic solvent, and treating the peroxide and the peroxide decomposition products that had precipitated with methanol, water, or the like to recover the insoluble content, a rubber typically having a Mw of about 10,000 or less is readily recovered, although the molecular weight of this rubber may be considerably lower than those recovered in the step (3).

When the rubber molded article treated in the present invention is a composite rubber product comprising different types of vulcanized rubbers, the rubber components may be separated by using difference in the solubility of the rubber components in the rubber solvent. For example, in the case of a laminate of a vulcanized natural rubber and a butyl rubber (IIR) liner, solubility in the rubber solvent of the natural rubber is higher than that of the butyl rubber, and the natural rubber and the butyl rubber can be separated by separating into the phase wherein the natural rubber has dissolved in the rubber solvent and the phase wherein the butyl rubber has remained undissolved (wherein the butyl rubber substantially retains its shape of solid liner).

The step (ii) as described above which uses the rubber solvent has the merit of low energy consumption in the recovery of the carbon black.

In the present invention, the material recovery process of steps (1) to (3) for the rubber recovery, and the material recovery process of steps (1), (2), and (4) for the carbon black recovery may be conducted as separate process, or alternatively, both the rubber and the carbon black may be recovered in consecutive steps (1) to (4).

The rubber and the carbon black recovered in the process as described above are well adapted for recycling in further rubber production, and the present invention also provides rubber compositions produced by incorporating either or both of the recovered rubber and the recovered carbon black. The rubber composition containing such recovered materials may contain the recovered rubber at least as a part of the rubber component included therein, and an adequate blend ratio may be selected for the recovered rubber and the virgin rubber depending on the intended use of the product. The rubber component used may solely comprise the recovered rubber. Similarly, the rubber composition containing such recovered materials may contain the recovered carbon black at least as a part of the carbon black used in the rubber composition, and an adequate blend ratio may be selected for the recovered carbon black and the virgin carbon black depending on the intended use of the product. The carbon black used may solely comprise the recovered carbon black.

### EXAMPLES

Next, the present invention is described in further detail by referring to the Examples which by no means limit the scope of the present invention.

### Example 1

<Rubber Molded Article>

A vulcanized rubber was produced by preparing a rubber compound comprising 100 parts by weight of NR (natural rubber), 50 parts by weight of carbon black (ASTM code, N118), 5 parts by weight of zinc oxide, 3 parts by weight of stearic acid, 1 part by weight of antiaging agent, 1.2 parts by weight of vulcanization aid, and 1.8 parts by weight of sulfur, and heating the rubber compound to a temperature of 148° C. for 10 minutes.

Decomposition test was conducted as described below by using the thus obtained vulcanized rubber.

(1) The vulcanized rubber that had been produced as described above was diced into cubes of 2 mm×2 mm×2 mm, and the cubes were loaded in heat resistant tubes at 7 to 15 mg/cm³.

The tubes were preheated in a quartz glass tube furnace in nitrogen atmosphere at temperature 220° C., 250° C., 280° C. and 300° C. for 15 minutes, 25 minutes, and 35 minutes, respectively.

(2) 30 g of the molded rubber cubes that had been heated as described above were immersed in 270 ml of toluene, and slow stirring was continued at room temperature for 24 hours. The toluene extract and the extraction residue were then separated by centrifugation.

(3) The toluene extract was placed in an evaporator to remove the toluene and recover the rubber.

(4) The extraction residue was heat treated at 600° C. for 30 minutes in nitrogen atmosphere to recover the carbon black.

The rubber recovered in the above (3) was evaluated for the molecular weight by GPC. The results are shown in Table 1.

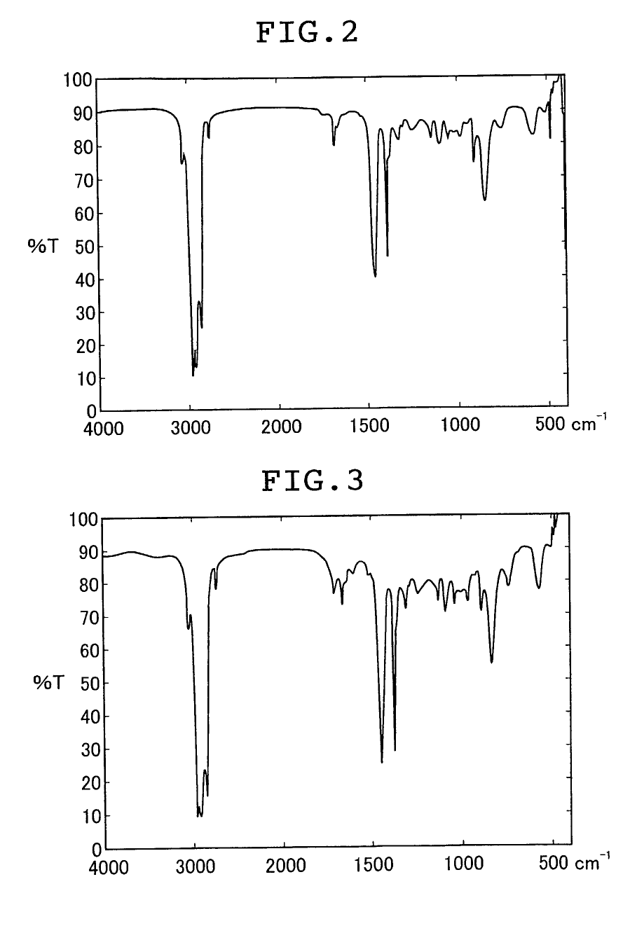

IR spectrum of the samples recovered were also measured, and it was confirmed that they were isoprene rubber. Of these samples, the IR spectrum of sample No. 1-(4) in Table 1 is shown in FIG. 2.

TABLE 1

| Heating | Heating | | | | |
|---|---|---|---|---|---|
| Time | Temperature | 220° C. | 250° C. | 280° C. | 300° C. |
| Sample No. | | 1-(1) | 1-(2) | 1-(3) | 1-(4) |
| 15 min. | Mw | 93000 | 84000 | 76000 | 26000 |
| | Rubber yield (%) | 20 | 31 | 74 | 81 |
| Sample No. | | 1-(5) | 1-(6) | 1-(7) | 1-(8) |
| 25 min. | Mw | 92000 | 73000 | 65000 | 25000 |
| | Rubber yield (%) | 22 | 34 | 77 | 77 |
| Sample No. | | 1-(9) | 1-(10) | 1-(11) | 1-(12) |
| 35 min. | Mw | 91000 | 72000 | 45000 | 18000 |
| | Rubber yield (%) | 24 | 35 | 84 | 77 |

(in nitrogen atmosphere)

### Example 2

The procedure of Example 1 was repeated except that, of the conditions employed in the heating, the time and the temperature were replaced with those shown in Table 2, and the atmosphere used was replaced with air to thereby recover the rubber. The results are shown in Table 2. In the GPC of the resulting rubber samples, 2 or 3 molecular weight distribution peaks were observed in the samples that had been treated in the preheat treatment at the lower temperatures. The molecular weights of the peaks and the weight ratio are indicated under the Table 2. IR spectrum of the samples recovered were also measured, and it was confirmed that they were isoprene rubber. IR spectrum of sample No. 2-(4) in Table 2 is shown in FIG. 3

TABLE 2

Sample No.

| Heating | Heating | 2-(1) | 2-(2) | 2-(3) | 2-(4) |
|---|---|---|---|---|---|
| Time | Temperature | 220° C. | 250° C. | 280° C. | 300° C. |
| 15 min. | Mw | 47000*¹ | 52000*² | 36000 | 15000 |
| | Rubber yield | 38*¹ | 40*² | 73 | 76 |
| | (%) | | | | |

| | |
|---|---|
| *¹Mw = | 108000/24000/6000 |
| | 33/23/37 |
| *²Mw = | 69000/3400 |
| | 64/24 |

### Example 3 and Reference Example 1

<Composition Containing the Recycled Rubber>

Rubber compositions were prepared by recycling the rubber recovered in Example 1, No. 1-(2) (Mw, 84,000; preheating at a temperature of 250° C. for 15 minutes), and the rubber recovered in Example 1, No. 1-(4) (Mw, 26,000; preheating at a temperature of 300° C. for 15 minutes), respectively, and the compositions were vulcanized. To be more specific, rubber compositions were prepared as in the case of Example 1 except that, in the composition of the rubber molded article produced in Example 1, the NR (natural rubber) used at an amount of 100 parts by weight was replaced with the same amount (100 parts by weight) of the rubber mixture prepared by mixing the rubber of No. 1-(2) or the rubber of No. 1-(4) with the NR (virgin rubber) at the weight ratio shown in Table 3, and the rubber compositions were vulcanized.

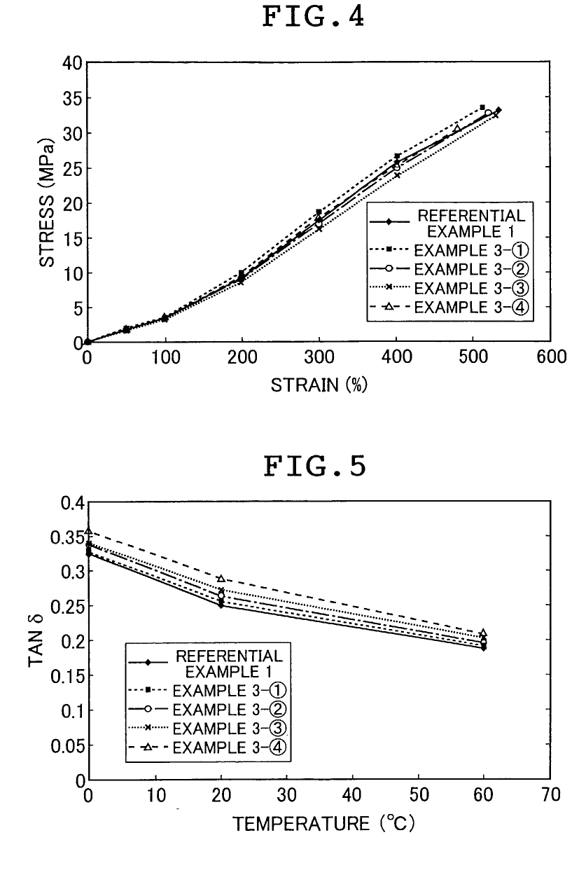

The vulcanized rubbers produced as described above, and the vulcanized rubber of the rubber molded article produced in Example 1 (Reference Example 1) were evaluated for their Stress-strain (S-S) properties and loss tangent (tan δ) as described below. The stress-strain (S-S) curve is shown in FIG. 4, and the temperature-loss tangent (tan δ) curve is shown in FIG. 5.

The 300% modulus (M₃₀₀), strength at break (TB), elongation at break (EB), energy corresponding to the area determined from the S-S curve (ENG) measured in the evaluation of the stress strain properties, and the value of tan δ at different temperatures are shown in Table 3.

<Stress-strain (S-S) Properties>

A dumbbell-shaped test strip (JIS No. 3) having a thickness of 1 mm was cut out. The test strip was evaluated for 300% modulus (M₃₀₀) [MPa], strength at break (TB) [MPa], elongation at break (EB) [%], and energy corresponding to the area determined from the S-S curve (ENG) [MPa] in accordance with the procedure described in JIS K 6251.

<Measurement of Loss Tangent (Tan δ)>

A rectangular test strip of the rubber composition having a width of 5 mm, a length of 100 mm, and a thickness of 1 mm was cut out. The test strip was evaluated for loss tangent (tan δ at 0° C., 20° C., and 60° C. in accordance with the procedure described in JIS K 6394 (initial strain, 10%; amplitude, ±2%; frequency, 20 Hz).

TABLE 3

| | | | | | Reference |
|---|---|---|---|---|---|
| | 3-(1) | 3-(2) | 3-(3) | 3-(4) | Example |
| | Amount of each rubber | | | | |
| | (amount in pbw per 100 pbw of rubber components) | | | | |
| NR (virgin | 95 | 90 | 95 | 90 | 100 |
| rubber) | | | | | |
| Received | 5 | | | | |
| Rubber 1-(2) | | 10 | | | |
| Received | | | 5 | | |
| rubber 1-(4) | | | | 10 | |
| Stress-strain | | | | | |
| properties | | | | | |
| M₃₀₀ (MPa) | 18.6 | 17.1 | 16.2 | 17.9 | 17.3 |
| TB (MPa) | 33.7 | 32.9 | 32.6 | 30.6 | 33.3 |
| EB (%) | 512 | 520 | 529 | 479 | 533 |
| ENG (MPa) | 77.3 | 76.0 | 74.7 | 64.5 | 81.4 |
| tan δ | | | | | |
| 0° C. | 0.325 | 0.337 | 0.340 | 0.357 | 0.323 |
| 20° C. | 0.254 | 0.264 | 0.271 | 0.287 | 0.248 |
| 60° C. | 0.189 | 0.194 | 0.201 | 0.206 | 0.186 |
| (*/100) | (102) | (104) | (108) | (111) | (100) |

*The value when the tan δ at 60° C. of Reference Example 1 is assumed to be 100.

<Composition Containing the Recycled Rubber>

The carbon black recovery step (4) of Example 1 (heating to 600° C. for 30 minutes) was conducted in air to recover the carbon black.

The carbon black produced by thermal decomposition of the extraction residue of the rubber which had been subjected to the preheating step at 250° C. for 15 minutes and additional preheating step at 280° C. for 15 minutes was designated UFA-1. The carbon black produced by thermal decomposition of the extraction residue of the preheating step 1-(4) was designated UFA-2. Other steps, namely, steps (1) to (3) were carried out as in the case of Example 1.

Vulcanized rubbers were prepared as in the case of Example 1 except that, in the composition of the rubber molded article produced in Example 1, the carbon black used were replaced with the carbon black UFA-1 or UFA-2, and the rubber compositions were vulcanized. The rubber molded article produced by using the virgin carbon black (N118) is shown in Table 4 as Reference Example 2.

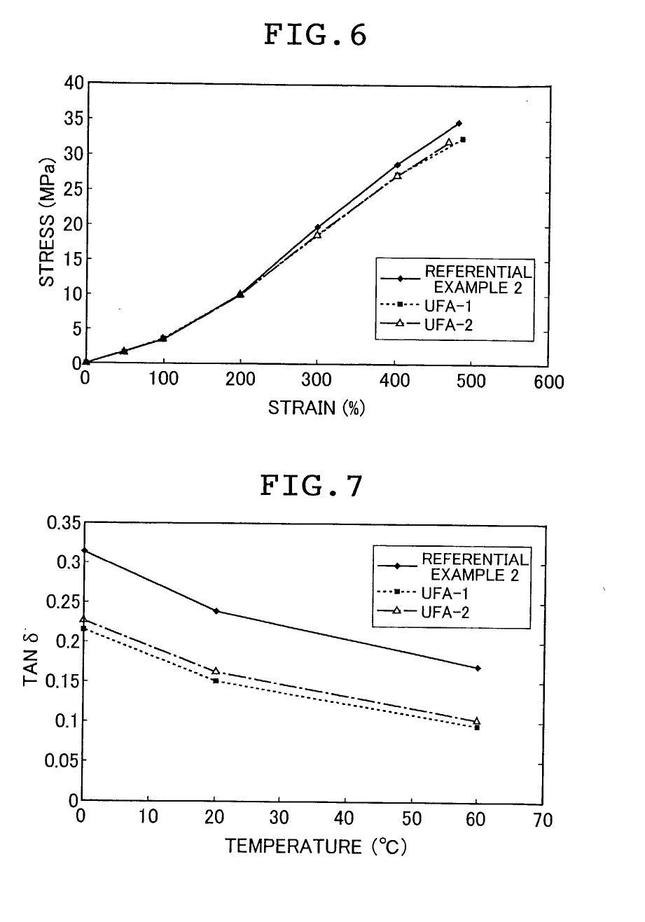

The stress-strain (S-S) properties and loss tangent (tan δ) were measured as in the case of Example 6. The results are shown in FIG. 6 (stress-strain (S-S) properties), FIG. 7 (temperature-tan δ properties), and Table 4.

TABLE 4

| | | | |
|---|---|---|---|
| | | | Reference |
| Carbon black | UFA-1 | UFA-2 | Example 2 |

Stress-strain
properties

| | | | | |
|---|---|---|---|---|
| M₃₀₀ | (MPa) | 19.1 | 19.3 | 20.1 |
| TB | (MPa) | 32.8 | 32.6 | 35.1 |
| EB | (%) | 485 | 467 | 480 |
| ENG | (MPa) | 77.3 | 66.2 | 73.3 |

| | | | |
|---|---|---|---|
| tan δ | | | |
| 0° C. | 0.216 | 0.228 | 0.313 |
| 20° C. | 0.150 | 0.162 | 0.238 |
| 60° C. | 0.096 | 0.104 | 0.170 |
| (*/100) | (56) | (61) | (100) |

*) Virgin carbon black was used in Reference Example 2. The value in the bracket is the value when the tan δ at 60° C. of Reference Example 2 is assumed to be 100.

### Example 5

Butyl rubber was recovered by using the bladder used in the molding and vulcanizing process of passenger-vehicle tires (produced by using IIR having a Mw of 450,000 for the starting rubber).

The rubber component was recovered by repeating the procedure of Example 1, steps (1) to (3) except that the rubber molded article treated in step (1) was the butyl rubber molded article as described above, and the preheating conditions were replaced with the heating for 15 minutes at the temperatures indicated in Table 5 (300° C., 330° C., 350° C., and 380° C.).

In the step (4), the extraction residue was heat treated at 600° C. for 30 minutes in nitrogen atmosphere to recover the carbon black.

The rubbers recovered in the step (3) were measured for their molecular weight by GPC. The results are shown in Table 5 together with the yield. The extract obtained by extracting the unvulcanized rubber produced by using the starting rubber as described above in accordance with the step (2) had a Mw of 420,000.

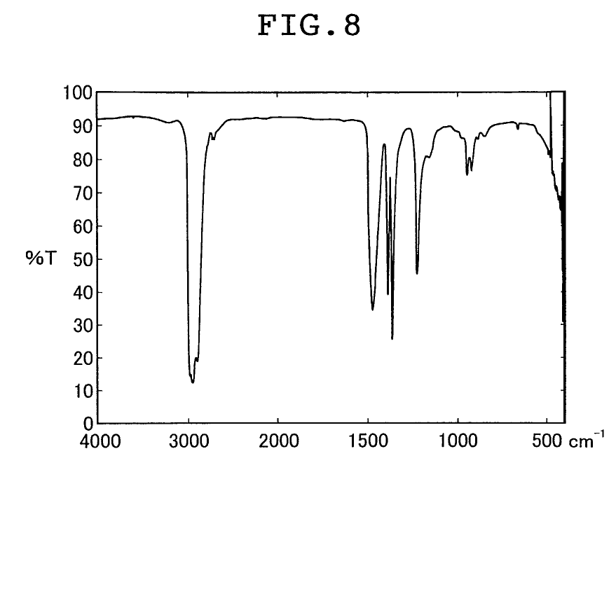

IR spectrum of the samples recovered was also measured, and they were confirmed to be butyl rubber. IR spectrum of sample No. 5-(3) in Table 5 is shown in FIG. 8.

TABLE 5

| Sample No. | 5-(1) | 5-(2) | 5-(3) | 5-(4) |
|---|---|---|---|---|
| Heating | 300° C. | 330° C. | 350° C. | 380° C. |
| temperature | | | | |
| Mw | 178000 | 60000 | 29000 | 9000 |
| Rubber | 55 | 75 | 81 | 46 |
| yield (%) | | | | |

### Example 6

Experiment of recovering natural rubber (NR) and carbon black materials was conducted by using tire tread (bent edge formed in the molding) having a known composition.

(1) tire tread was introduced and kneaded in a twin screw extruder (screw diameter, 44 mm; L/D, 50) under the condition (feed amount, cylinder temperature, and time kneaded) shown in Table 6.

(2) The strand extruded from the twin screw extruder was cut into dices of 5 mm×5 mm×5 mm. 30 g was immersed in 270 ml of toluene, and after slowly stirring at room temperature for 24 hours, the toluene extract and the extraction residue were separated.

(3) Toluene was removed from the toluene extract in an evaporator to thereby recover the rubber.

(4) The extraction residue was treated in nitrogen atmosphere at 600° C. for 30 minutes to recover the carbon black.

The results of the rubber recovery in the above (3) are shown in Table 6. The rubbers recovered were measured for their molecular weight by GPC.

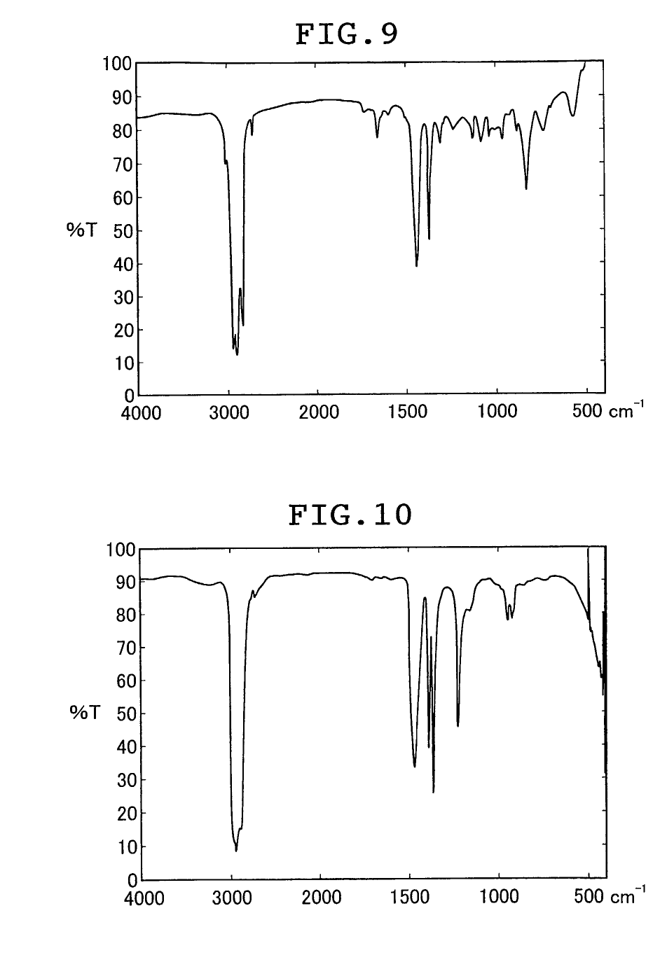

IR spectrum of the sample recovered was also measured, and the sample was confirmed to be isoprene rubber. IR spectrum of the rubber recovered in Example 6 is shown in FIG. 9. The C═O peak was substantially absent, indicating that the rubber had a fine microstructure, and that the isoprene recovered was high purity isoprene.

### Example 7

The procedure of Example 6 was repeated to recover the rubber except that the molded rubber article treated was bladder (butyl rubber) and the step (1) was accomplished under the kneading conditions as shown in Table 6. IR spectrum of the samples recovered was also measured, and it was confirmed that they were butyl rubber. The results are shown in Table 6. IR spectrum of the sample recovered in Example 7 is shown in FIG. 10.

TABLE 6-1

| | | | Kneading Conditions | | | | |
|---|---|---|---|---|---|---|---|
| | | | | | Cylinder | | |
| | | | | | temp. (° C.) at | | |
| | | | Rotation | Inlet | intermediate | Outlet | Kneading |
| | | Feed | speed | temp. | portion of | temp. | time |
| | | (kg/hour) | (rpm) | (° C.) | the cylinder | (° C.) | (min.) |
| Example 6 | Tread | 260 | 250 | 120 | 290 | 210 | 7 |
| | (NR) | | | | | | |
| Example 7 | Bladder | 260 | 250 | 150 | 310 | 260 | 7 |
| | (butyl | | | | | | |
| | rubber) | | | | | | |

TABLE 6-2

| | | Recovered rubber | | |
|---|---|---|---|---|
| | | Yield | | Microstructure |
| | | (%) | Mw | (IR) |
| Example 6 | Tread (NR) | 74 | 59000 | ◯ |
| Example 7 | Bladder | 80 | 151000 | ◯ |
| | (butyl rubber) | | | |

### Examples 8 and 9

In Example 6, step (1), the shearing treatment was conduced at room temperature by using Akron abrasion tester instead of the twin screw extruder.

The procedure of Example 6 was repeated except that tread rubber for TB (truck and bus) (NR, Example 8) and tread rubber for PC (passenger car) (SBR, Example 9) were abraded into powder in an abrasion tester (load, 5.4 kg; tilt angle, 22.5 degrees). The results of the rubber recovery are shown in Table 7. The IR spectrum of the recovered rubbers indicated that they have fine microstructure corresponding to the respective starting rubber.

TABLE 7

| | Rubber recover | | Microstructure |
|---|---|---|---|
| | (%) | Mw | (IR) |
| Example 8 | 7 | 35,000 | ◯ |
| Example 9 | 12 | 45,000 | ◯ |

### Reference Example 3

A vulcanized rubber was produced by preparing a rubber compound comprising 100 parts by weight of NR (natural rubber), 50 parts by weight of carbon black (ASTM code, N118), 5 parts by weight of zinc oxide, 3 parts by weight of stearic acid, 1 part by weight of antiaging agent, 1.2 parts by weight of vulcanization aid, and 1.8 parts by weight of sulfur, and heating the rubber compound to a temperature of 148° C. for 10 minutes. The thus produced vulcanized rubber was measured for the stress-strain properties (S-S properties and loss tangent (tan δ) as described below. The results are shown in Table 8.

<Stress-strain (S-S) Properties>

A dumbbell-shaped test strip (JIS No. 3) having a thickness of 1 mm was cut out. The test strip was evaluated for 300% modulus (M₃₀₀) [MPa], strength at break (TB) [MPa], elongation at break (EB) [%], and energy corresponding to the area determined from the S-S curve (ENG) [MPa] in accordance with the procedure described in JIS K 6251.

<Measurement of Loss Tangent (Tan δ)>

A rectangular test strip of the rubber composition having a width of 5 mm, a length of 100 mm, and a thickness of 1 mm was cut out. The test strip was evaluated for loss tangent (tan δ) at 0° C., 20° C., and 60° C. in accordance with the procedure described in JIS K 6394 (initial strain, 10%; amplitude, ±2%; frequency, 20 Hz).

### Example 10

<Composition Containing the Recycled Rubber>

Vulcanized rubber was produced by repeating the procedure of Reference Example 3 except that a part (10 parts by weight) of the natural rubber (virgin rubber) was replaced with the recycled rubber recovered in Example 6 (Mw, 59,000). The thus produced vulcanized rubber had the rubber properties as shown in Table 8

<Composition Containing the Recovered Carbon Black>

Vulcanized rubber was produced by repeating the procedure of Reference Example 3 except that the carbon black (virgin carbon black) was replaced with the recycled carbon black recovered in Example 6. The thus produced vulcanized rubber had the rubber properties as shown in Table 8

TABLE 8

| | | Example 10 | Example 11 | Reference Example 3 |
|---|---|---|---|---|
| Rubber (pbw) | | NR | NR | NR |
| | | (virgin rubber) 90 | (virgin rubber) 100 | (virgin rubber) 100 |
| | | Recovered rubber 10 | | |
| Carbon black (pbw) | | Virgin carbon black | Recovered carbon | Recovered carbon |
| | | 50 | black 50 | black 50 |
| Stress strain | | | | |
| properties | | | | |
| M₃₀₀ | (MPa) | 17.3 | 19.4 | 20.0 |
| TB | (MPa) | 33.1 | 32.1 | 33.6 |
| EB | (%) | 510 | 469 | 494 |
| ENG | (MPa) | 76.1 | 67.9 | 77.3 |
| tan δ | | | | |

| | | | |
|---|---|---|---|
| 0° C. | 0.339 | 0.236 | 0.311 |
| 20° C. | 0.265 | 0.169 | 0.238 |
| 60° C. | 0.198 | 0.111 | 0.173 |
| (/*100) | (114) | (64) | (100) |

The value in the bracket is the value when the tan δ at 60° C. of Reference Example 3 is assumed to be 100.

### MERITS OF THE INVENTION

The present invention as described above has enabled reliable recovery of the materials useful as the rubber raw materials such as high purity rubbers, and in particular, high purity isoprene rubber and butyl rubber, and carbon black from discarded rubbers such as discarded tires, bladders, other discarded molded articles, scrap rubbers, discarded rubber wire sleeves, and the like.

What is claimed is:

1. A process for recovering materials from a rubber molded article comprising the steps of
(1) subjecting the rubber molded article to at least one pretreatment selected from the following:
(a) a heat treatment at a temperature in the range of 220 to 400° C. wherein shape of the articles before the heating is substantially preserved, and
(b) a treatment of applying a shearing force,
(2) extracting the product of (1) with an organic solvent for separation into the solvent extract and the extraction residue, and
(3) removing the solvent from the separated solvent extract to thereby recover the rubber.

2. A process for recovering materials from a rubber molded article containing carbon black and rubber comprising the steps of
(1) subjecting the rubber molded article to at least one pretreatment selected from the following:
(a) a heat treatment at a temperature in the range of 220 to 400° C. wherein shape of the articles before the heating is substantially preserved, and
(b) a treatment of applying a shearing force,
(2) extracting the product of (1) with an organic solvent for separation into the solvent extract and the extraction residue, and
(4) subjecting the separated extraction residue to either one of the following:
(i) heating to a temperature of 500° C. or higher, and
(ii) dissolving in a rubber solvent containing 0.01 to 50 wt % of a peroxide to thereby decompose the rubber component and recover the carbon black.

3. A process for recovering materials from a rubber molded article containing carbon black and rubber comprising the steps of
(1) subjecting the rubber molded article to at least one pretreatment selected from the following:
(a) a heat treatment at a temperature in the range of 220 to 400° C. wherein shape of the articles before the heating is substantially preserved, and
(b) a treatment of applying a shearing force,
(2) extracting the product of (1) with an organic solvent for separation into the solvent extract and the extraction residue,
(3) removing the solvent from the separated solvent extract to thereby recover the rubber.
(4) subjecting the separated extraction residue to either one of the following:
(i) heating to a temperature of 500° C. or higher, and
(ii) dissolving in a rubber solvent containing 0.01 to 50% of a peroxide to thereby decompose the rubber component and recover the carbon black.

4. A process for recovering materials according to claim 1 wherein, in said step (2), said solvent extraction is immersion in toluene at a temperature of 0 to 40° C. of said rubber molded article which had been heat treated in said step (1).

5. A process for recovering materials according to claim 2 wherein, in said step (2), said solvent extraction is immersion in toluene at a temperature of 0 to 40° C. of said rubber molded article which had been heat treated in said step (1).

6. A process for recovering materials according to claim 3 wherein, in said step (2), said solvent extraction is immersion in toluene at a temperature of 0 to 40° C. of said rubber molded article which had been heat treated in said step (1).

7. A process for recovering materials according to claim 2 wherein, in said heating of said extraction residue to a temperature of 500° C. or higher in said step (4) (i), the rubber component is decomposed into gaseous hydrocarbons to thereby recover the carbon black as the decomposition residue.

8. A process for recovering materials according to claim 3 wherein, in said heating of said extraction residue to a temperature of 500° C. or higher in said step (4) (i), the rubber component is decomposed into gaseous hydrocarbons to thereby recover the carbon black as the decomposition residue.

9. A process for recovering materials according to claim 2 wherein the rubber solvent used in said step (4) (ii) is toluene containing 0.01 to 50% of benzoyl peroxide.

10. A process for recovering materials according to claim 3 wherein the rubber solvent used in said step (4) (ii) is toluene containing 0.01 to 50% of benzoyl peroxide.

11. A rubber recovered by the recovering process according to claim 1 wherein the rubber recovered is a liquid rubber having an average molecular weight (Mw) of 50,000 or more.

12. A rubber according to claim 11 wherein said rubber is isoprene rubber.

13. A rubber according to claim 11 wherein said rubber is butyl rubber.

14. A carbon black recovered by the recovering process according to claim 2.

15. A carbon black recovered by the recovering process according to claim 3.

16. A carbon black recovered by the recovering process according to claim 7.

17. A carbon black recovered by the recovering process according to claim 9.

18. A rubber composition containing a material recycled from a rubber molded article, wherein said material is the rubber of claim 11.

19. A rubber composition containing a material recycled from a rubber molded article, wherein said material is the carbon black of claim 14.
